(19) United States
(12) Patent Application Publication
(10) Pub. No.: US 2017/0049202 A1
(43) Pub. Date: Feb. 23, 2017

(54) Automatic Following Luggage System

(71) Applicant: Edinaldo Nascimento, Kew Gardens, NY (US)

(72) Inventor: Edinaldo Nascimento, Kew Gardens, NY (US)

(21) Appl. No.: 15/243,846

(22) Filed: Aug. 22, 2016

Related U.S. Application Data
(60) Provisional application No. 62/208,056, filed on Aug. 21, 2015.

(51) Int. Cl. A45C 13/26; G05D 1/00; A45C 13/36; A45C 13/30; A45C 5/03; A45C 5/14

(52) U.S. Cl. CPC A45C 13/262; A45C 5/03; A45C 5/146; A45C 13/36; A45C 13/30; G05D 1/0016; A45C 2005/035; A45C 2005/037; A45C 2013/267; A45C 2013/306

(57) ABSTRACT

A luggage system is provided. The luggage system comprises at least one piece of luggage with the at least one piece of luggage having a top surface, a bottom surface, and a plurality of side surfaces. A plurality of wheels are mounted on the bottom surface of the at least one piece of luggage. A motor is associated with each of the wheels. An activatable sensor is positioned on the top surface of the at least one piece of luggage and a wearable device communicates with the sensor. Upon activation of the sensor, the motors associated with each of the wheels are energized causing the at least one piece of luggage to move in a general direction toward the wearable device. The at least one piece of luggage moves independently without manual transporting of the at least one piece of luggage.

### CLAIM OF PRIORITY

This patent application claims priority under 35 USC 119 (e) (1) from U.S. Provisional Patent Application Ser. No. 62/208,056 filed Aug. 21, 2015, of common inventorship herewith entitled, “Luggage Matic,” which is incorporated herein by reference as though the same were set forth in its entirety.

### FIELD OF THE INVENTION

The present invention pertains to the field of travel accessories, and more specifically to the field of portable luggage.

### BACKGROUND OF THE INVENTION

Whereas previous generations dreamt of traveling at will, today it is a reality for many across the globe. From a family embarking on a road trip to visit relatives or a newlywed couple taking a honeymoon cruise to an adventurous grandmother boarding a cross country train or a seasoned business traveler racking up scores of frequent flyer miles, millions of people set out on trips every day. Regardless if one is driving to the next town or flying to a foreign land, travelers endeavor to pack all essentials needed while away from home. Aside from an obvious change of clothing, items such as books, music players and cell phone chargers are staples of many traveling bags. Another necessity travelers never leave home without is a variety of personal care products. Shampoo, shaving cream, toothbrush and toothpaste, deodorant, mouthwash, sanitary napkins and sunscreen are a few examples of toiletries one finds necessary for any journey.

While packing a suitcase for travel is necessary, actually transporting packed luggage is a challenging task. Utilizing traditional suitcases and travel bags involves the burden of balancing the entire weight of a bag on one arm or shoulder while manipulating larger suitcases across facility floors and concrete surfaces. Straining muscles of one's neck and back by carrying packed suitcases is exhausting, particularly for elderly consumers and those people who are not in the best physical shape. Although luggage manufacturers began adding two wheels to suitcases to facilitate transport, the luggage often is too heavy and awkward for a user to comfortably handle, and also transporting several bags at once is problematic.

The prior art has put forth several designs for portable luggage. Among these are:

US Patent Publication 2004/0129469 to Sarteep Kader describes a self propelling suitcase comprising a storage compartment, a plurality of wheels and a means for driving at least one wheel. A sensor senses a transmitted signal. The suitcase has a means for guiding the suitcase toward the source of the transmitted signal. A separate signal transmitter is carried by the user for transmitting a signal to be detected by the sensor on the suitcase, whereby the suitcase will follow the user.

U.S. Pat. No. 5,316,096 to Sidney R. Good describes a portable motorized suitcase which is operable in a self propelling or manual mode. The suitcase includes an extendable handle which contains a multi position switch, allowing a user to choose between modes of operation and selectively control the speed of the suitcase. A motor conveys power to the ground engaging wheel by means of a centrifugal clutch arrangement. The clutch allows the motor to propel the suitcase when it is in the self propelling mode without hindering the rolling of the wheels when the motor is in the manual mode. The motor and clutch arrangement turns the wheels or allows them to free wheel, depending upon the operator's positioning of the multi position switch. Transition between modes of operation occurs automatically in accordance with user manipulation of the switch. The motor is supplied with power from a removable battery pack. The rear wheels of the suitcase, one of which is selectively driven by the motor, are outwardly spaced from the sidewalls of the suitcase to stably support the suitcase during movement thereof.

U.S. Pat. No. 4,913,252 to B. Dean Bartley and George Spector describes an article of motorized luggage that consists of a plurality of wheels rotatably journaled to bottom of a container body for allowing travel along the ground and a mechanism within the container body for driving one of the wheels to make the luggage a self-powered device. In a modified embodiment, a steerable platform is connected to the luggage so as to transport a person standing upon the platform.

None of these prior art references describe the present invention.

### SUMMARY OF THE INVENTION

It is an object of the present invention to provide a line of travel suitcases equipped with sensor operated, automatic wheels to provide luggage pieces which move independently without travelers physically struggling to transport heavy baggage.

The present invention is a luggage system. The luggage system comprises at least one piece of luggage with the at least one piece of luggage having a top surface, a bottom surface, and a plurality of side surfaces. A plurality of wheels are mounted on the bottom surface of the at least one piece of luggage. A motor is associated with each of the wheels. An activatable sensor is positioned on the top surface of the at least one piece of luggage and a wearable device communicates with the sensor. Upon activation of the sensor, the motors associated with each of the wheels are energized causing the at least one piece of luggage to move in a general direction toward the wearable device. The at least one piece of luggage moves independently without manual transporting of the at least one piece of luggage.

In addition, the present invention includes a method comprising providing at least one piece of luggage, the at least one piece of luggage having a top surface, a bottom surface, and a plurality of side surfaces, mounting a plurality of wheels on the bottom surface of the at least one piece of luggage, associating a motor with each of the wheels, positioning an activatable sensor on the top surface of the at least one piece of luggage, communicating a wearable device with the sensor, activating the sensor, energizing the motors, and moving the at least one piece of luggage in a general direction toward the wearable device.

The present invention further includes a luggage system comprising at least one piece of luggage with the at least one piece of luggage having a top surface, a bottom surface, and a plurality of side surfaces. A plurality of wheels are mounted on the bottom surface of the at least one piece of luggage. A motor is associated with each of the wheels. An activatable sensor is positioned on the top surface of the at least one piece of luggage. The sensor is touch operated as an internally contained passive infrared detector setting up multiple zones of detection within a semicircular field of view using a lens with such viewing capability. A wearable device communicates with the sensor. A distance detection device is electronically connected to the sensor for maintaining a predetermined distance between the at least one piece of luggage and the wearable device. Upon activation, the sensor sends a pulse to the motor in each of the wheels, energizing the motors, and causing the wheels to rotate and causing the at least one piece of luggage to begin to roll in a general direction toward the wearable device. The at least one piece of luggage moves independently without manual transporting of the at least one piece of luggage.

### BRIEF DESCRIPTION OF THE DRAWINGS

FIG. 1 is a perspective view illustrating an automatic luggage following system, constructed in accordance with the present invention, with a luggage set containing three pieces of luggage with each piece being a different size.

FIG. 2 is a perspective view illustrating the automatic luggage following system, constructed in accordance with the present invention, showing two luggage pieces and wheels along with a sturdy connecting strip running underneath each luggage to securely attach the first luggage piece to the second luggage piece.

FIG. 3 is a perspective view illustrating the automatic luggage following system, constructed in accordance with the present invention, showing an integrated sensor for operating the movement of the luggage piece.

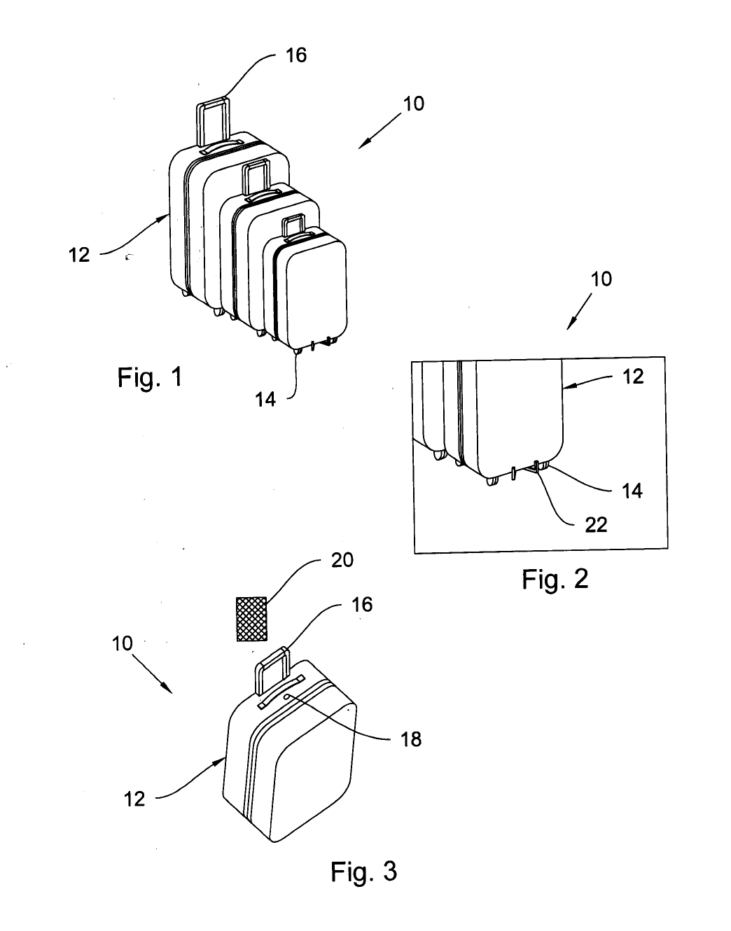

### DETAILED DESCRIPTION OF THE INVENTION

The present invention, hereinafter referred to as an Automatic Following Luggage System, indicated generally at 10, is a line of travel suitcases 12 equipped with sensor operated, automatic wheels 14 allowing the luggage 12 to automatically follow the user. The Automatic Following Luggage System 10 provides luggage 12 pieces that move independently on their own without users having to struggle to lug heavy baggage 12. Travelers no longer strain muscles and experience physical overexertion having to manually carry or pull heavy baggage 14. Similar in appearance to a standard suitcase, the luggage 14 of the Automatic Following Luggage System 10 is generally rectangular in shape and produced in a variety of sizes. A useful standard size of the luggage 14, is comparable in size to a carryon suitcase. The carryon sized luggage 14 of the Automatic Following Luggage System 10 preferably measures approximately fifty-six centimeters in height, forty five centimeters in width, and twenty five centimeters in depth. Larger sizes, capable of holding more clothing, and therefore would be heavier, optimizes the automatic movement features of the present invention.

Comprising a durable aluminum and plastic framework as well as heavy duty plastic components, the luggage 12 of the Automatic Following Luggage System 10 is manufactured in a soft and durable vinyl, canvas or leather material or is produced as a hard suitcase made primarily of plastic. The luggage 12 preferably contains reinforced plastic corners to allow soft versions to maintain a rectangular shape.

Hidden within the back of the luggage 12 of the Automatic Following Luggage System 10 of the present invention is a U shaped, telescoping handle 16 with the top of the handle 16 positioned on the top of the luggage 12. Appropriately positioned on the underside of the luggage 12 to facilitate transport are approximately four heavy duty wheeled casters 14 that automatically retract when the luggage 12 is stationary. The wheels 14 are augmented to turn the luggage 12 into an automatically mobile luggage by means of a lightweight, compact sensor and motor system.

A sensor 18 is located on the top corner of the luggage 12 of the Automatic Following Luggage System 10 of the present invention. Preferably, the sensor 12 is touch operated as an internally contained passive infrared detector, which sets up multiple zones of detection within a semicircular field of view using a lens with such viewing capability. The user carries or wears a device 20 for communicating with the infrared detector 18. The device 20 can include, but is not limited to, a card, fob, cell phone, etc.

Upon activation, the sensor 18 of the Automatic Following Luggage System 10 of the present invention sends a pulse to a small motor in each of the wheels 14 of the case, causing the wheels to rotate and causing the luggage to begin to roll forward in a general direction toward the user device 20. A distance detection device is connected within the sensor 18 to maintain the distance between the luggage 12 and the user. The distance detection device measures a distance between the luggage 12 and the user, controls the speed and direction, prevents troubles caused by manual dragging, substantially mitigate burdens of people in travelling, and helps people to do other things by hands.

Another component of the Automatic Following Luggage System 10 of the present invention incorporates a connector strip 22 for attaching additional luggage, so that multiple bags or cases can piggyback and roll with Automatic Following Luggage System 10 technology. Power is provided by a rechargeable battery source such as nickel cadmium or nickel metal hydride. The luggage 12 of the Automatic Following Luggage System 10 is produced in a variety of striking colors as well as standard black or gray.

Comprising a durable, four wheeled design operated by a sensor activated motor, the Automatic Following Luggage System 10 of the present invention enables travelers to transport goods without the need to physically carry or push. A practical alternative to handled or two wheeled suitcases which cause unnecessary strain and stress to one's arms, neck, and shoulder muscles during transport, the lightweight and automated Automatic Following Luggage System 10 is easily and comfortably transported. The aforementioned connector strip 22 provides an easy way of transporting other luggage, smaller travel, and garment bags, purses and similar goods, and even child care accessories such as a car seat, portable crib or similar gear, thus enabling users to transport the many goods necessary for an extended sojourn all with one suitcase. Durably constructed of quality materials, the Automatic Following Luggage System 10 will withstand years of continued and reliable use.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claim.

1. A luggage system comprising:
at least one piece of luggage, the at least one piece of luggage having a top surface, a bottom surface, and a plurality of side surfaces;
a plurality of wheels mounted on the bottom surface of the at least one piece of luggage;
a motor associated with each of the wheels;
an activatable sensor positioned on the top surface of the at least one piece of luggage; and
a wearable device communicating with the sensor;
wherein upon activation of the sensor, the motors associated with each of the wheels are energized causing the at least one piece of luggage to move in a general direction toward the wearable device; and
wherein the at least one piece of luggage moves independently without manual transporting of the at least one piece of luggage.

2. The luggage system of claim 1 wherein the at least one piece of luggage is substantially rectangular in shape and produced in a variety of sizes.

3. The luggage system of claim 1 wherein the at least one piece of luggage is sized to a standard carry-on suitcase.

4. The luggage system of claim 1 wherein the luggage is constructed in a soft and durable vinyl, canvas or leather material or a hard suitcase made primarily of plastic.

5. The luggage system of claim 4 wherein soft sided luggage has reinforced plastic corners.

6. The luggage system of claim 1 and further comprising:
a U shaped, telescoping handle mounted within a side surface of the at least one piece of luggage, the top of the handle positioned adjacent the top surface of the at least one piece of luggage.

7. The luggage system of claim 1 wherein the plurality of wheels automatically retract when the at least one piece of luggage is stationary.

8. The luggage system of claim 1 wherein the sensor is touch operated as an internally contained passive infrared detector setting up multiple zones of detection within a semicircular field of view using a lens with such viewing capability.

9. The luggage system of claim 1 wherein the wearable device is selected from the group consisting of a card, a fob, and a cell phone.

10. The luggage system of claim 1 wherein upon activation, the sensor sends a pulse to the motor in each of the wheels causing the wheels to rotate and causing the at least one piece of luggage to begin to roll in a general direction toward the wearable device.

11. The luggage system of claim 1 and further comprising:
a distance detection device electronically connected to the sensor for maintaining a predetermined distance between the at least one piece of luggage and the wearable device.

12. The luggage system of claim 11 wherein the distance detection device controls speed and direction of the wheels.

13. The luggage system of claim 1 and further comprising:
a connector strip secured to the at least one piece of luggage;
wherein multiple pieces of luggage are securable to the connector strip.

14. A method comprising:
providing at least one piece of luggage, the at least one piece of luggage having a top surface, a bottom surface, and a plurality of side surfaces;
mounting a plurality of wheels on the bottom surface of the at least one piece of luggage;
associating a motor with each of the wheels;
positioning an activatable sensor on the top surface of the at least one piece of luggage;
communicating a wearable device with the sensor;
activating the sensor;
energizing the motors; and
moving the at least one piece of luggage in a general direction toward the wearable device.

15. A luggage system comprising:
at least one piece of luggage, the at least one piece of luggage having a top surface, a bottom surface, and a plurality of side surfaces;
a plurality of wheels mounted on the bottom surface of the at least one piece of luggage;
a motor associated with each of the wheels;
an activatable sensor positioned on the top surface of the at least one piece of luggage, the sensor being touch operated as an internally contained passive infrared detector setting up multiple zones of detection within a semicircular field of view using a lens with such viewing capability;
a wearable device communicating with the sensor; and
a distance detection device electronically connected to the sensor for maintaining a predetermined distance between the at least one piece of luggage and the wearable device;
wherein upon activation, the sensor sends a pulse to the motor in each of the wheels, energizing the motors, and causing the wheels to rotate and causing the at least one piece of luggage to begin to roll in a general direction toward the wearable device; and
wherein the at least one piece of luggage moves independently without manual transporting of the at least one piece of luggage.

16. The luggage system of claim 15 and further comprising:
a U shaped, telescoping handle mounted within a side surface of the at least one piece of luggage, the top of the handle positioned adjacent the top surface of the at least one piece of luggage.

17. The luggage system of claim 15 wherein the plurality of wheels automatically retract when the at least one piece of luggage is stationary.

18. The luggage system of claim 15 wherein the wearable device is selected from the group consisting of a card, a fob, and a cell phone.

19. The luggage system of claim 15 wherein the distance detection device controls speed and direction of the wheels.

20. The luggage system of claim 15 and further comprising:
a connector strip secured to the at least one piece of luggage;
wherein multiple pieces of luggage are securable to the connector strip.
